(19) United States
(12) Patent Application Publication
(10) Pub. No.: US 2021/0080555 A1
(43) Pub. Date: Mar. 18, 2021

(54) METHOD AND LIDAR DEVICE FOR SCANNING A SCANNING AREA WITH THE AID OF AT LEAST TWO PULSE-ENCODED BEAMS

(71) Applicant: Robert Bosch GmbH, Stuttgart (DE)

(72) Inventors: Annemarie Holleczek, Stuttgart (DE); Tobias Peterseim, Boeblingen (DE)

(21) Appl. No.: 16/629,733

(22) PCT Filed: Jul. 2, 2018
(86) PCT No.: PCT/EP2018/067726

§ 371 Date: Jan. 9, 2020

(30) Foreign Application Priority Data
Jul. 10, 2017 (DE) 102017211707.9

(51) Int. Cl. G01S 7/499; G01S 7/481; G01S 17/10

(52) U.S. Cl. CPC G01S 7/499; G01S 17/10; G01S 7/4817; G01S 7/4814

(57) ABSTRACT

A LIDAR device for scanning a scanning area with the aid of at least two consecutively generated beams, in terms of time, including at least one radiation source for generating and emitting the at least two beams in a pulse-pause pattern in the direction of the scanning area, and including at least one detector for receiving at least two beams scattered and/or reflected on an object, the at least two generated beams being differently polarizable by a polarization encoder, and the detector including a polarization analyzer, which compares the scattered and/or reflected beams to a defined polarization sequence, and, in the event of an agreement of the polarization sequence of the at least two scattered and/or reflected beams with the defined polarization sequence, transmits the at least two reflected beams. Also described is a method for operating a

### FIELD OF THE INVENTION

The present invention relates to a LIDAR device for scanning a scanning area with the aid of at least two consecutively generated beams and to a method for operating a LIDAR device.

### BACKGROUND INFORMATION

Light detection and ranging (LIDAR) devices are of essential importance for autonomous and semi-autonomous vehicles, for example for determining distances or movement directions of objects. In particular, it is crucial that a LIDAR device cannot be influenced by the irradiation of extraneous light, for example, of other or identical LIDAR devices. In this way, it is possible to detect erroneous signals or ghost objects, for example. Another problem of LIDAR devices is deliberate irradiation of laser light, for example by laser pointers, or other dazzling attacks, whereby, in addition to an erroneous signal detection, an interruption of the LIDAR device may be provoked. A LIDAR device is known from DE 10 2013 219 344 A1 in which each of multiple radiation sources is provided with a separate polarization filter, which have different polarization directions. The different radiation sources radiate laser beams having a respective constant polarization in a pulse-pause pattern. A separate radiation source and a separate polarization filter having an orientation different from the other polarization filter are necessary for each of the different polarizations of the beams.

### SUMMARY OF THE INVENTION

An object underlying the present invention is to provide a method and a LIDAR device having a high security against the action of extraneous light and dazzling attacks, while having a technically simple and compact configuration.

This object is achieved with the aid of the respective subject matter as described herein. Advantageous embodiments of the present invention are the subject matter of the respective further descriptions herein.

According to one aspect of the present invention, a LIDAR device for scanning a scanning area with the aid of at least two consecutively generated beams is provided. The LIDAR device includes at least one radiation source for generating and for emitting the at least two beams in a pulse-pause pattern in the direction of the scanning area. Beams reflected and/or scattered on an object may be received by at least one detector of the device. According to the present invention, the at least two generated beams are differently polarizable by a polarization encoder, the at least one detector including a polarization analyzer, which compares the reflected or scattered beams to a defined polarization sequence. If the polarization sequence of the at least two reflected or scattered beams agrees with the polarization sequence defined by the polarization encoder, the at least two reflected or scattered beams are transmittable for detection.

The LIDAR device generates at least two beams in a pulse-shaped manner in the process, which thus form a defined pulse-pause pattern. At least two generated beams having at least one pause between the beams may form a pulse pattern. Each generated beam or beam pulse of the pulse pattern is assigned a defined polarization direction by the polarization encoder. In particular, each beam is polarized with a specific polarization direction by the polarization encoder. Generated beams thus encoded may subsequently be irradiated via the mirror into the scanning area. The generated beams may be deflected and emitted in the direction of the scanning area directly or, for example, via a mirror. In the case of a so-called macroscanner, transmitters of light beams and receivers of light beams are situated on a rotating unit, this being a rotor, a stator surrounding this rotor. In the case of a so-called Flash LIDAR or a solid state LIDAR, the generated beams may be emitted directly into the scanning area. An additional macro or micro mirror, which is able to deflect the generated beams, is situated on the so-called scanning LIDAR devices. As an alternative or in addition, the mirror may also guide the reflected or scattered beams onto a detector, if the detector is situated on a stator. The mirror may be a vertically pivotable mirror, for example, which is situated on a rotor. The rotor may additionally rotate or pivot the mirror horizontally. The generated beams may thus be deflected along a horizontal scan angle and along a vertical scan angle or emitted out of the LIDAR device. As an alternative, the mirror may also be situated on the stator and be configured to be deflectable or pivotable. The horizontal scan angle and the vertical scan angle form the scanning area. If objects or obstacles are situated in the scanning area, the generated beams are reflected or scattered on the objects or obstacles and become reflected beams. For the sake of simplicity, the “reflected beams” may be both reflected and scattered. The reflected beams at least partially maintain their original specific polarization direction and may be received by the LIDAR device with the aid of an appropriate receiving lens system or directly with the aid of at least one detector. The detector includes a polarization analyzer, which is situated in front of a detector surface. The polarization analyzer may also be provided upstream from the detector as a separate component. The reflected beams first impinge on the polarization analyzer before they reach a detector surface of the detector. The polarization analyzer and/or the polarization encoder may be configured as a Pockels cell. The polarization analyzer may be linked to the polarization encoder. In this way, the polarization analyzer is already able to experience the assigned specific polarization directions of the respective beams during their assignment, and awaits receipt of the reflected beams with the appropriate encoding. The polarization analyzer is configured in such a way that only reflected beams having the specific polarization or encoding are allowed to pass to the detector or to the detector surface for detection. The polarization encoder thus encodes the generated beams with a particular polarization direction, or encodes multiple generated beams with a sequence of different or identical polarization directions. In this way, it is possible to prevent that irradiation on the detector from sources other than the radiation source of the LIDAR device are taken into consideration in the detection and evaluation. As a result of the polarization encoder and the polarization analyzer, the LIDAR device may be configured to be more secure and less prone to errors. Compared to conventional LIDAR devices, a technical complexity of the device is only little increased.

According to one exemplary embodiment of the LIDAR device, the polarization encoder incrementally changes the polarization vectors of the at least two generated beams. The polarization encoder may utilize the pauses between the beams generated in a pulse-shaped manner for this purpose, to set a defined specific polarization for a next beam to be generated. In particular, a linear polarization having an angle may be used as the polarization. The angle indicates the polarization direction. In this way, an angle of the linear polarization may be incrementally changed or adapted. In the case of multiple consecutive beams, several beams may also have an identical polarization or polarization direction. As an alternative, individual or multiple beams may also be circularly or elliptically polarized.

According to another exemplary embodiment of the LIDAR device, the polarization encoder continuously changes the polarization vectors of the at least two generated beams. The polarization encoder may thus vary an angle of the linear polarization using a constant or a variable rate and specifically encode the generated beams or provide them with a specific polarization direction. It is also advantageous that a linking of the polarization encoder with the polarization analyzer may be dispensed with when the rate or the velocity with which the polarization direction changes is known. Variable velocities may be defined by algorithms, for example, and be stored in the polarization analyzer so that the encoding of the reflected beams may be reliably identified.

According to another exemplary embodiment of the LIDAR device, the polarization encoder includes a polarization rotator. The polarization encoder may be a rotatable wave plate. Generated beams may thus be polarized, and thus encoded, as a function of an orientation of the polarization rotator. The polarization rotator may be a half wave plate, for example. The polarization rotator may be rotated at constant velocities, at variable velocities or incrementally in keeping with the pulse frequency of the radiation source. The polarization encoder may include a drive for this purpose, such as a step motor. The orientation of the polarization rotator may be registered with the aid of a sensor and transmitted to the polarization analyzer with the aid of a control unit. It is also possible for defined polarization angles to be set with the aid of the sensor. As an alternative to the dedicated drive, the polarization filter may also be situated on the rotor of the LIDAR device, or may be directly or indirectly drivable via the rotor.

As an alternative, the polarization encoder may also be a rotatable polarization filter. This polarization filter filters the desired polarization from the irradiated light by its orientation. The procedure is similar to the polarization rotator.

According to another exemplary embodiment of the LIDAR device, the radiation source clocks the duration of the pauses and pulses to be equally long or to have different durations. In addition to encoding the generated beams with a defined sequence of polarization directions of the respective beam pulses, it is also possible to use a duration of the pulses and the pauses present between the pulses for encoding. In this way, the pulse frequency of the radiation source may be kept constant or be varied. For example, different pauses within a pulse pattern may be implemented between the generated beams. As an alternative or in addition, the duration of the generated beam pulses within a beam pattern may be varied.

For example, the generated beams may be longer, in terms of time, than the pauses between the generated beams and/or vice versa. Different beam pulses may also be equally long, in terms of time, and may be followed by one or multiple beam pulse(s) of different durations.

According to another exemplary embodiment of the LIDAR device, a polarizing beam splitter, which splits the at least one reflected beam into different polarization components and guides them onto separate detectors, is provided downstream from the polarization analyzer. In addition to the polarization analyzer, a polarizing beam splitter may be situated between the polarization analyzer and the detector. The polarizing beam splitter may, for example, split the reflected beams into their vertical and horizontal polarization components and guide them, for example, onto two detectors for detection. In particular, the encoding of an arbitrary pulse pattern may be reconstructed and checked based on different detected intensities of the respective polarization components.

According to a further exemplary embodiment of the LIDAR device, the analyzer is a polarizing beam splitter. In this way, a separate polarization analyzer or polarization encoder may be completely dispensed with since the polarizing beam splitter together with at least two detectors may also assume the task of the polarization analyzer.

According to a further aspect of the present invention, a method for operating a LIDAR device for scanning a scanning area with the aid of at least one beam is provided. The at least two generated beams are generated in the form of a pulse pattern in the process and deflected along a horizontal scan angle and along a vertical scan angle. According to the present invention, a different or the same specific polarization direction is assigned to the at least two generated beams or pulses, at least one pulse having the specific polarization direction which is reflected on an object being guided by a polarization analyzer onto at least one detector.

In this way, a pulse pattern is created from at least two beams generated in a pulse-shaped manner, each pulse being assigned a defined specific polarization direction. Via a defined sequence of generated beams having a superimposed sequence of different and/or identical polarization directions, it is possible to implement an encoding by the polarization encoder in combination with the radiation source, which may be identified via the polarization analyzer. In particular, a disruption in an operation of the LIDAR device due to extraneous light or spurious reflections may be prevented. Only the generated pulse patterns provided with the specific encoding are detected or taken into consideration in the detection. Furthermore, so-called LIDAR hacks may be prevented by such an encoding and decoding of the generated and reflected beams, and an operational security of the LIDAR device may be increased.

According to one exemplary embodiment of the method, an identical polarization direction is assigned to multiple consecutive pulses before the specific polarization direction is changed by the polarization encoder. In this way, the pulse pattern may be encoded by a plurality of different options. In addition to an encoding of the respective beam pulses by respective different polarization directions, it is also possible for multiple consecutive beam pulses to have an identical polarization direction. Moreover, combinations of sequences of identical polarization directions with varied polarization directions are possible. In this way, multiple LIDAR devices of identical configuration may also function side by side without interference.

Exemplary embodiments of the present invention are described in greater detail hereafter based on highly simplified schematic representations.

In the figures, the same configuration elements in each case have the same reference numerals.

### BRIEF DESCRIPTION OF THE DRAWINGS

FIG. 1 shows a schematic representation of a LIDAR device according to a first exemplary embodiment.

FIG. 2 shows a schematic representation of a LIDAR device according to a second exemplary embodiment.

FIG. 3 shows a schematic representation of a LIDAR device according to a third exemplary embodiment.

FIGS. 4a and 4b show examples of generated and encoded pulse patterns.

FIGS. 5a and 5b show the received intensity distribution of the LIDAR device according to the second exemplary embodiment.

### DETAILED DESCRIPTION

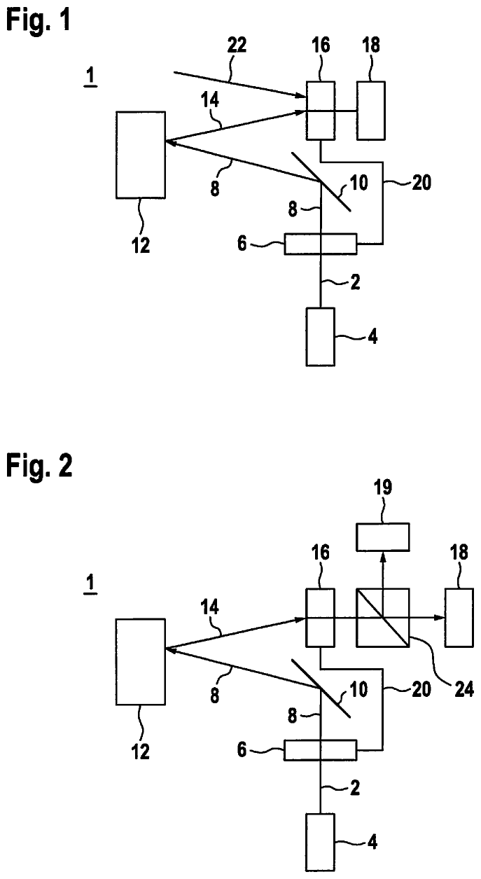

FIG. 1 shows a schematic representation of a LIDAR device 1 for scanning a scanning area with the aid of at least two consecutively generated beams 2 according to a first exemplary embodiment. LIDAR device 1 includes a radiation source 4, which is an infrared laser 4, for example. Radiation source 4 generates beams 2 or laser beams 2 in the form of pulses 2. In particular, the radiation source generates at least two consecutive beams 2, which together form a pulse pattern. The pulse pattern is, in particular, a pulse-pause pattern since a pause follows each generated beam 2 or pulse 2. After being generated, the generated beams 2 pass a polarization encoder 6. Polarization encoder 6 is made up of, in particular, a linear polarization rotator and a corresponding activation or evaluation logic. In this way, the polarization rotator may be rotated differently and thus create an additional encoding in the form of an individual polarization for each pulse 2, in addition to the pulse-pause pattern. Encoded beams 8 may subsequently be deflected in a controlled manner by a pivotable mirror 10 along a vertical scan angle and a horizontal scan angle, and thus expose or scan a scanning area. As an alternative, instead of a movable mirror 10, it is also possible to use a rotatable or pivotable radiation source 4, including a polarization encoder 6 situated in front of radiation source 4, for scanning a scanning area. For example, radiation source 4 and polarization encoder 6 may be situated on a rotor. If an object 12 is present in the scanning area, the generated and encoded beams 8 may be at least partially reflected by this object 12. The encoding is also at least partially maintained in the process. The generated and encoded beams 8 become reflected beams 14 as a result of the reflection on object 12.

Reflected beams 14 may be received by a polarization analyzer 16. Polarization analyzer 16 is provided upstream from detector 18 and is linked to polarization encoder 6 via data lines 20. Polarization analyzer 16 thus knows the last encoding of the generated pulse pattern assigned to polarization encoder 6. According to the exemplary embodiment, polarization analyzer 16 is a rotatable, linear polarization filter, which may be set or rotated according to the predefined encoding by polarization encoder 6 to be able to transmit reflected beams 14. If the encoding of reflected beams 14 agrees with the specific encoding of polarization encoder 6, reflected beam 14 may pass polarization analyzer 16 in the direction of detector 18 unimpeded. In this way, scattered light 22 or undesirable extraneous irradiation 22 may be blocked by polarization analyzer 16, or at least arrive at detector 18 in weakened form, if irradiation 22 does not have the specific encoding.

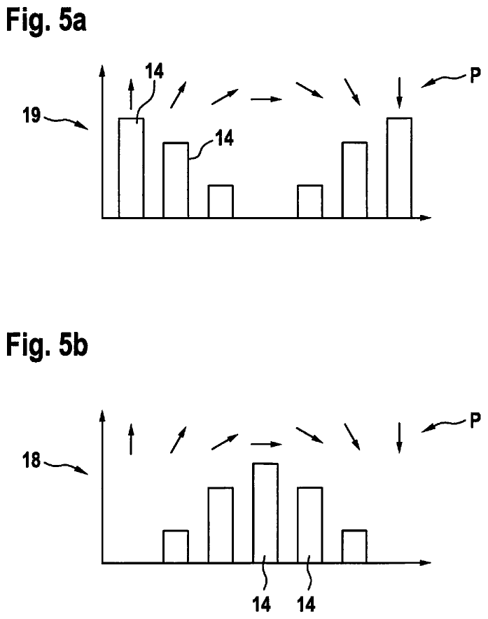

FIG. 2 shows a schematic representation of a LIDAR device 1 according to a second exemplary embodiment. In contrast to LIDAR device 1 according to the first exemplary embodiment, LIDAR device 1 includes a polarizing beam splitter 24, which is provided downstream from polarization analyzer 16. Beams 14 reflected by object 12 may thus pass polarization analyzer 16 unimpeded due to their encoding, and may subsequently be deflected by polarizing beam splitter 24 corresponding to their polarization components of their polarization vector P to a first detector 18 or a second detector 19. According to the exemplary embodiment, polarizing beam splitter 24 splits the linearly polarized reflected beams 14 or the individual reflected pulses 14 corresponding to their horizontally polarized polarization component of their polarization vector P and corresponding to their vertically polarized polarization components. FIGS. 5a and 5b illustrate this principle in detail.

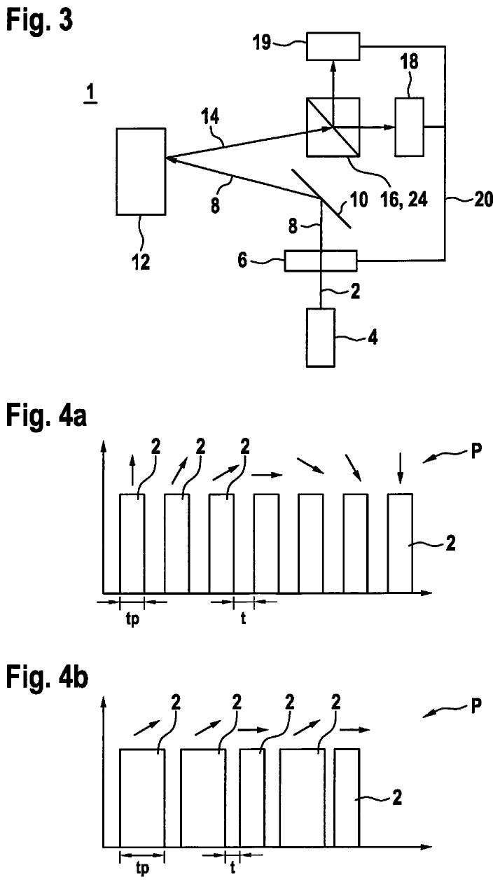

FIG. 3 shows a schematic representation of a LIDAR device 1 according to a third exemplary embodiment. In contrast to the second exemplary embodiment of LIDAR device 1, polarization analyzer 16 is configured as a polarizing beam splitter 16, 24. A separate polarization analyzer 16, such as is shown in the first exemplary embodiment, for example, may thus be dispensed with. Polarizing beam splitter 16, 24 itself is not able to directly distinguish unencoded beams 22 from encoded reflected beams 14. The two detectors 18, 19 are linked to polarization encoder 6 via data lines 20 and may establish based on the signals received from detectors 18, 19 whether received beams 14, 22 were encoded with the aid of polarization encoder 6. By splitting polarization vectors P of the respective beams 14, 22, polarization vector P of received beams 14, 22 may be reconstructed by a combination of detectors 18, 19. In this way, a polarization direction of the respective beam pulses 14, 22 may also be compared to the polarization directions of the generated beam pulses 8. In the event of an agreement of the polarization directions of the generated beams 8 and of the reflected received beams 14, the corresponding signals are used for further evaluation. All residual signals may remain unconsidered.

FIG. 4a shows beam pulses 2 generated by way of example, which were encoded with a continuously varied polarization direction or polarization vector P. Pulses 2 here were provided with a polarization with the aid of a rotatable linear polarization filter of polarization encoder 6 of LIDAR device 1 according to the first exemplary embodiment. The individual beam pulses 2 are plotted in an intensity-time diagram. The horizontal axis corresponds to the intensity. The vertical axis corresponds to a chronological progression. The individual beam pulses 2 have an identical pulse duration tp and an identical pause t, in terms of time, between beam pulses 2. The encoding here takes place via the sequence of the different polarization vectors P which was assigned to the respective beams 2.

FIG. 4b shows an alternative example of possible beam pulses 2, which were also plotted in an intensity-time diagram. Pulse duration tp of the individual beam pulses 2 is varied by radiation source 4. An assignment of a polarization vector P is carried out by polarization encoder 6 as a function of pulse duration tp. The first two beam pulses 2 in the diagram here are equally long, in terms of time, and have an identical polarization vector P. The further beam pulses 2 are varied in their pulse duration tp and in terms of their polarization vectors P.

FIGS. 5a and 5b show received intensity distributions of first detector 18 and of second detector 19 of the LIDAR device according to the second exemplary embodiment. Polarizing beam splitter 24 splits received beam pulses 14 into their horizontal and vertical polarization components corresponding to their polarization vectors P. For example, a vertically polarized beam exclusively has vertical polarization components. In this way, for example, only second detector 19 detects a signal. In the case of a polarization vector P extending diagonally, both detectors 18, 19 detect a signal. The received signals or intensities of the signals are dependent on the direction of polarization vectors P.

1-9. (canceled)

10. A LIDAR device for scanning a scanning area with at least two consecutively generated beams, comprising:
at least one radiation source to generate and emit the at least two beams in a pulse-pause pattern in the direction of the scanning area; and
at least one detector to receive at least two beams scattered and/or reflected on an object;
wherein the at least two generated beams are differently polarizable by a polarization encoder,
wherein the at least one detector includes a polarization analyzer to compare the scattered and/or reflected beams to a defined polarization sequence, and
wherein, in the event of an agreement of the polarization sequence of the at least two scattered and/or reflected beams with the defined polarization sequence, the at least two scattered and/or reflected beams are transmitted for detection.

11. The LIDAR device of claim 10, wherein the polarization encoder incrementally changes the polarization vectors of the at least two generated beams.

12. The LIDAR device of claim 10, wherein the polarization encoder continuously changes the polarization vectors of the at least two generated beams.

13. The LIDAR device of claim 10, wherein the polarization encoder includes a polarization rotator.

14. The LIDAR device of claim 10, wherein the radiation source clocks a duration of the pauses and a duration of the pulses to be equally or differently long.

15. The LIDAR device of claim 10, further comprising:
a polarizing beam splitter, which splits the at least one reflected beam into different polarization components and guides them onto separate detectors, downstream from the polarization analyzer.

16. The LIDAR device of claim 10, wherein the polarization analyzer includes a polarizing beam splitter.

17. A method for operating a LIDAR device for scanning a scanning area with at least one beam, the method comprising:
generating at least two beams in the form of a pulse pattern;
deflecting the at least two pulses along a horizontal scan angle and along a vertical scan angle;
assigning a specific polarization direction to the at least two pulses; and
guiding, at least one pulse, having the specific polarization direction which is scattered or reflected on an object, by a polarization analyzer onto at least one detector;
wherein the LIDAR device includes:
at least one radiation source to generate and emit the at least two beams in a pulse-pause pattern in the direction of the scanning area; and
the at least one detector to receive at least two beams scattered and/or reflected on an object;
wherein the at least two generated beams are differently polarizable by the polarization encoder,
wherein the at least one detector includes the polarization analyzer to compare the scattered and/or reflected beams to a defined polarization sequence, and
wherein, in the event of an agreement of the polarization sequence of the at least two scattered and/or reflected beams with the defined polarization sequence, the at least two scattered and/or reflected beams are transmitted for detection.

18. The method of claim 17, wherein an identical polarization direction is assigned to multiple consecutive pulses before the specific polarization direction is changed by the polarization encoder.
